(19) United States
(12) Patent Application Publication
(10) Pub. No.: US 2018/0330422 A1
(43) Pub. Date: Nov. 15, 2018

(54) RECOMMENDER SYSTEMS AND METHODS FOR PRICING AND EVALUATION OF FINE ART WORKS

(71) Applicants: Zbigniew W. RAS, Charlotte, NC (US); Anna GELICH, Moscow (RU)

(72) Inventors: Zbigniew W. RAS, Charlotte, NC (US); Anna GELICH, Moscow (RU)

(73) Assignee: The University Of North Carolina At Charlotte, Charlotte, NC (US)

(21) Appl. No.: 15/974,771

(22) Filed: May 9, 2018

Related U.S. Application Data
(60) Provisional application No. 62/506,282, filed on May 15, 2017.

(51) Int. Cl. G06Q 30/06; G06F 17/30; G06Q 30/02

(52) U.S. Cl. CPC G06Q 30/0631; G06Q 30/0283; G06F 17/3089

(57) ABSTRACT

Recommender systems and methods for the pricing and evaluation of fine art works. Fine art work market regulation using a crowd of recommender systems and methods built from relevant data and knowledge that is extracted from the Web. Advanced data mining techniques are used to construct a crowd of recommender systems for making recommendations about the pricing and evaluation of fine art works using the wisdom of selected members. The Semantic Web is a source of data and knowledge about artists and the associated fine art works. Relevant information is found and indexed using crawlers and deep Web crawlers. Advanced data mining techniques, including text mining, sentiment analysis, and guided folksonomy, are used to mine for knowledge and construct the recommender systems for the pricing of the fine art works. The wisdom of the constructed crowd is also used for identifying artists who can be recommended for promotion.

### CROSS-REFERENCE TO RELATED APPLICATION

The present patent application/patent claims the benefit of priority of co-pending U.S. Provisional Patent Application No. 62/506,282, filed on May 15, 2017, and entitled “RECOMMENDER SYSTEM FOR PRICING AND EVALUATION OF FINE ART WORKS,” the contents of which are incorporated in full by reference herein.

### FIELD OF THE DISCLOSURE

The present disclosure relates generally to recommender systems and methods for the pricing and evaluation of fine art works and the like. More specifically, the present disclosure relates to fine art work market regulation using a crowd of recommender systems and methods built from relevant data and knowledge that is extracted from the Web. Advanced data mining techniques are used to construct a crowd of recommender systems for making recommendations about the pricing and evaluation of fine art works using the wisdom of selected members. The Semantic Web is the main source of data and knowledge about artists and the associated fine art works. Relevant information residing on the Web is found and indexed using crawlers and deep Web crawlers. Advanced data mining techniques, including text mining, sentiment analysis, and guided folksonomy, are used to mine for knowledge and construct the recommender systems for the pricing of the fine art works. The wisdom of the constructed crowd is also used for identifying artists who can be recommended for promotion.

### BACKGROUND OF THE DISCLOSURE

Much research has been done in the area of recommender systems, but none concerning the construction of crowd of recommender systems from the clusters of semantically similar users (in this case, artists). Descriptions of users are stored as database tuples and they are built using advanced data mining techniques from the information about artists and fine art works residing on the Web. The number of recommender systems in the crowd is the same as the number of clusters. Since clusters can be built on different generalization levels, recommender systems forming the crowd can have hierarchical structures.

For instance, one research project has concerned group recommendations, tackling the consensus joint decision as a voting process that builds a majority opinion about a sequence of the most interesting natural attractions to visit by a group of tourists. This research project, however, does not construct a crowd of recommender systems using data mining techniques.

Another research project has investigated physical and digital urban navigation and suggested that implementing recommendations, based on social media voting systems, in route finding algorithms for mobile applications may enhance the pleasure of urban strolling. Again, this research project does not construct a crowd of recommender systems using data mining techniques.

Thus, what are still needed in the art are improved recommender systems and methods for the pricing and evaluation of fine art works and the like.

### BRIEF SUMMARY OF THE DISCLOSURE

In various exemplary embodiments, the present disclosure generally provides recommender systems and methods for the pricing and evaluation of fine art works and the like. More specifically, the present disclosure provides fine art work market regulation using a crowd of recommender systems and methods built from relevant data and knowledge that is extracted from the Web. Advanced data mining techniques are used to construct a crowd of recommender systems for making recommendations about the pricing and evaluation of fine art works using the wisdom of its selected members. The Semantic Web is the main source of data and knowledge about artists and the associated fine art works. Relevant information residing on the Web is found and indexed using crawlers and deep Web crawlers. Advanced data mining techniques, including text mining, sentiment analysis, and guided folksonomy, are used to mine for knowledge and construct the recommender systems for the pricing of the fine art works. The wisdom of the constructed crowd is also used for identifying artists who can be recommended for promotion.

In one exemplary embodiment, the present disclosure provides a method for providing a recommender system for the pricing and evaluation of fine art works and the like, including: building a plurality of initial datasets from information obtained from the Web, wherein the plurality of initial datasets include an initial Artist Dataset and an initial Artwork Dataset; adding features to the plurality of initial datasets to generate a plurality of final datasets that are configured to be datamined, wherein the plurality of final datasets include a final Artist Dataset and a final Artwork Dataset; introducing semantic distance into one or more of the plurality of final datasets; selectively associating the final Artist Dataset with the final Artwork Dataset; and for the plurality of final datasets, building classifiers and training a plurality of personalized recommender systems based on these classifiers, wherein the plurality of personalized recommender systems form a crowd of recommender systems configured to be used for evaluation and pricing of a new art piece submitted to the recommender system by a user. Building the plurality of initial datasets from information obtained from the Web includes: indexing webpages including the information; loading the indexed webpages into a full-text search engine application and parsing the indexed webpages; extracting data stored in the indexed and parsed webpages; loading the extracted data into a distributed database management system; and fetching images associated with the information to a file system. Adding features to the plurality of initial datasets to generate the plurality of final datasets that are configured to be datamined includes building the features using one or more of text mining, sentiment mining, and guided folksonomy. The method further includes applying agglomerative clustering to one or more of the plurality of final datasets to partition the one or more of the plurality of datasets into disjoint buckets of semantically similar categories. The recommender system is operable for receiving input and a query from the user. The input includes one or more of: (1) information related to one or more of an artist and the new art piece and (2) an image of the new art piece. The input is received by one or more of the plurality of personalized recommender systems and the crowd of recommender systems. The recommender system is operable for delivering output to the user including one or more of a suggested price for the new art piece and a recommendation for promotion related to the new art piece based on crowd wisdom.

In another exemplary embodiment, the present disclosure provides a recommender system for the pricing and evaluation of fine art works and the like, including: an algorithm stored in a memory and executed by a processor operable for building a plurality of initial datasets from information obtained from the Web, wherein the plurality of initial datasets include an initial Artist Dataset and an initial Artwork Dataset; an algorithm stored in the memory and executed by the processor operable for adding features to the plurality of initial datasets to generate a plurality of final datasets that are configured to be datamined, wherein the plurality of final datasets include a final Artist Dataset and a final Artwork Dataset; an algorithm stored in the memory and executed by the processor operable for introducing semantic distance into one or more of the plurality of final datasets; an algorithm stored in the memory and executed by the processor operable for selectively associating the final Artist Dataset with the final Artwork Dataset; and an algorithm stored in the memory and executed by the processor operable for, for each of the plurality of final datasets, building a classifier and training a plurality of personalized recommender systems using the classifiers, wherein the plurality of personalized recommender systems form a crowd of recommender systems configured to be used for evaluation and pricing of a new art piece submitted to the recommender system by a user. Building the plurality of initial datasets from information obtained from the Web includes: indexing webpages including the relevant information; loading the indexed webpages into a full-text search engine application and parsing the indexed webpages; extracting data stored in the indexed and parsed webpages; loading the extracted data into a distributed database management system; and fetching images associated with the information to a file system. Adding features to the plurality of initial datasets to generate the plurality of final datasets that are configured to be datamined includes building the features using one or more of text mining, sentiment mining, and guided folksonomy. The system further includes an algorithm stored in the memory and executed by the processor operable for applying agglomerative clustering to one or more of the plurality of final datasets to partition the one or more of the plurality of datasets into disjoint buckets of semantically similar categories. The recommender system is operable for receiving input and a query from the user. The input includes one or more of: (1) information related to one or more of an artist and the new art piece and (2) an image of the new art piece. The input is received by one or more of the plurality of personalized recommender systems and the crowd of recommender systems. The recommender system is operable for delivering output to the user including one or more of a suggested price for the new art piece and a recommendation for promotion related to the new art piece based on crowd wisdom.

In a further exemplary embodiment, the present disclosure provides a method for using a recommender system for the pricing and evaluation of fine art works and the like, including: accessing the recommender system; providing user input and a user query to the recommender system, wherein the input includes one or more of: (1) information related to one or more of an artist and a new art piece and (2) an image of the new art piece, and wherein the input is received by one or more of a plurality of personalized recommender systems and a crowd of recommender systems; and receiving output from the recommender system including one or more of a suggested price for the new art piece and a recommendation for promotion related to the new art piece based on crowd wisdom. The recommender system is constructed by: building a plurality of initial datasets from information obtained from the Web, wherein the plurality of initial datasets include an initial Artist Dataset and an initial Artwork Dataset; adding features to the plurality of initial datasets to generate a plurality of final datasets that are configured to be datamined, wherein the plurality of final datasets include a final Artist Dataset and a final Artwork Dataset; introducing semantic distance into one or more of the plurality of final datasets; selectively associating the final Artist Dataset with the final Artwork Dataset; and for each of the plurality of final datasets, building a classifier and training the plurality of personalized recommender systems based on these classifiers, wherein the plurality of personalized recommender systems form the crowd of recommender systems configured to be used for the evaluation and pricing of the new art piece submitted to the recommender system by a user. Building the plurality of initial datasets from information obtained from the Web includes: indexing webpages including relevant information; loading the indexed webpages into a full-text search engine application and parsing the indexed webpages; extracting data stored in the indexed and parsed webpages; loading the extracted data into a distributed database management system; and fetching images associated with the information to a file system. Adding features to the plurality of initial datasets to generate the plurality of final datasets that are configured to be datamined includes building the features using one or more of text mining, sentiment mining, and guided folksonomy. The recommender system is further constructed by applying agglomerative clustering to one or more of the plurality of final datasets to partition the one or more of the plurality of datasets into disjoint buckets of semantically similar categories. From the data residing in each bucket, a recommender system is built and added to the recommender systems crowd.

In a still further exemplary embodiment, the present disclosure provides a recommender system for the pricing and evaluation of fine art works and the like, including: an algorithm stored in a memory and executed by a processor operable for allowing a user to access the recommender system; an algorithm stored in the memory and executed by the processor operable for receiving user input and a user query at the recommender system, wherein the input includes one or more of: (1) information related to one or more of an artist and a new art piece and (2) an image of the new art piece, and wherein the input is received by one or more of a plurality of personalized recommender systems and a crowd of recommender systems; and an algorithm stored in the memory and executed by the processor operable for delivering output from the recommender system to the user including one or more of a suggested price for the new art piece and a recommendation for promotion related to the new art piece based on crowd wisdom. The recommender system is constructed by: building a plurality of initial datasets from information obtained from the Web, wherein the plurality of initial datasets include an initial Artist Dataset and an initial Artwork Dataset; adding features to the plurality of initial datasets to generate a plurality of final datasets that are configured to be datamined, wherein the plurality of final datasets include a final Artist Dataset and a final Artwork Dataset; introducing semantic distance into one or more of the plurality of final datasets; selectively associating the final Artist Dataset with the final Artwork Dataset; and for each of the plurality of final datasets, building a classifier and training the plurality of personalized recommender systems using the classifiers, wherein the plurality of personalized recommender systems form the crowd of recommender systems configured to be used for the evaluation and pricing of the new art piece submitted to the recommender system by a user. Building the plurality of initial datasets from information obtained from the Web includes: indexing webpages including the information; loading the indexed webpages into a full-text search engine application and parsing the indexed webpages; extracting data stored in the indexed and parsed webpages; loading the extracted data into a distributed database management system; and fetching images associated with the information to a file system. Adding features to the plurality of initial datasets to generate the plurality of final datasets that are configured to be datamined includes building the features using one or more of text mining, sentiment mining, and guided folksonomy. The recommender system is further constructed by applying agglomerative clustering to one or more of the plurality of final datasets to partition the one or more of the plurality of datasets into disjoint buckets of semantically similar categories.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flowchart illustrating one exemplary embodiment of a method for constructing a recommender system crowd in accordance with the systems and methods of the present disclosure; and

FIG. 2 is a flowchart illustrating one exemplary embodiment of a query answering scheme in accordance with the systems and method of the present disclosure.

### DETAILED DESCRIPTION OF THE DISCLOSURE

Again, in various exemplary embodiments, the present disclosure generally provides recommender systems and methods for the pricing and evaluation of fine art works and the like. More specifically, the present disclosure provides fine art work market regulation using a crowd of recommender systems and methods built from relevant data and knowledge that is extracted from the Web. Advanced data mining techniques are used to construct a crowd of recommender systems for making recommendations about the pricing and evaluation of fine art works using the wisdom of selected members. The Semantic Web is the main source of data and knowledge about artists and the associated fine art works. Relevant information residing on the Web is found and indexed using crawlers and deep Web crawlers. Advanced data mining techniques, including text mining, sentiment analysis, and guided folksonomy, are used to mine for knowledge and construct the recommender systems for the pricing of the fine art works. The wisdom of the constructed crowd is also used for identifying artists who can be recommended for promotion.

In other words, the systems and methods of the present disclosure build and use a crowd of web-based personalized recommender systems for evaluating and making recommendations about the pricing of fine art works. Confusion matrices, evaluating the quality of classifiers built from the data available on the Web about fine art sales, demonstrate that fine art works, in general, are overvalued, which makes classical approaches to building and using recommender systems rather questionable. If one builds a large dataset of fine art works and describes them by a number of features where price is a decision feature, the classifiers trained on that dataset assign price tags to new pieces of art that are too high. This means that one has to depress such prices for usefulness, but the question is by how much? This supports the wisdom of a crowd approach.

Personalized recommender systems for art evaluation form the relevant crowd. Personalization is achieved by introducing semantic distance between artists (for example, information about 649,010 artists is provided on the ArtPrice website). When referring to semantic distance, this definition takes into consideration artist achievements, education, similar sales in terms of price, similar types of art, and also what is likes and disliked (this information may now be extracted from the Web). For each group of semantically similar artists, personalized recommender system is built from the classifiers trained on the dataset describing artworks sold by artists being members of that group.

The quality of the classifiers strictly depends on the dataset features used for training. The systems and methods of the present disclosure extend the group of classical features readily extractable from the Web by semantic features obtained from mining billions of comments provided by users, artists' biographies, and images of paintings sold by them. For this purpose, sentiment mining and guided folksonomy are utilized. A wisdom crowd approach is used to obtain a recommendation for a price to be assigned to an artwork.

Since the clustering of artists can be done on different granularity/personalization levels, the present disclosure also utilizes a tree-structured hierarchy of recommender systems for artwork evaluation. This is referred to as a hierarchy of crowds for artwork evaluation herein.

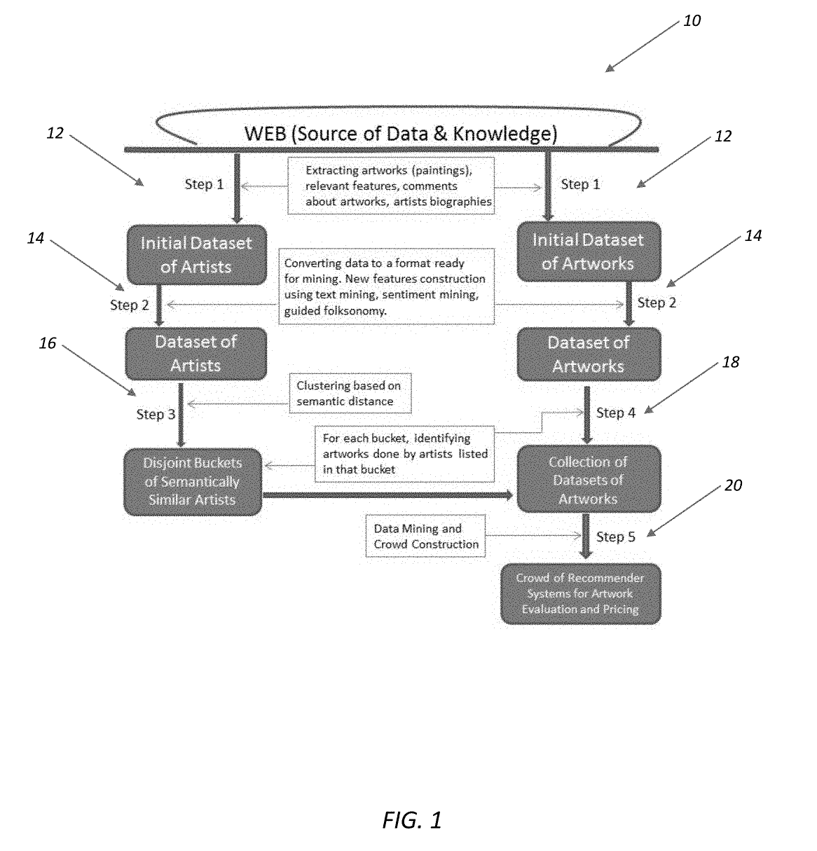

Referring now specifically to FIG. 1, in one exemplary embodiment, the construction of a recommender systems crowd 10 consists of five basic steps. Step 1 12 involves the process of building initial datasets from information obtained from the Web. Art related websites (for example, SaatchiArt Gallery and ArtPrice (lists 649,010 artists)) are indexed by an open source Web crawler, such as Apache Nutch or the like. The indexed pages are loaded into a full-text search engine application, such as Apache Solr or the like. Next, the web pages from Apache Solr or the like are parsed. With the use of the Sold Library or the like, access to Solr documents or the like is gained from the application level. Jsoup or the like, a HTML parser library, allows extraction of data stored in HTML documents. Data extracted from HTML is loaded into Apache Cassandra or the like, a distributed database management system. Images are fetched to a file system. Two datasets, one describing artists (Initial Dataset of Artists) and another describing artworks (Initial Dataset of Artworks) are thus built.

Step 2 14 involves converting the two initial datasets (built in Step 1 12) to a table format ready for datamining. From the fetched text data (i.e., comments about artists and artworks, artist biographies etc.), new features are built using text mining, sentiment mining, and guided folksonomy, among other possible tools. These features are then added to the initial datasets and, as the final result, the “Dataset of Artists” and “Dataset of Artworks” are generated.

Step 3 16 involves introducing semantic distance in the “Dataset of Artists,” for example. Agglomerative clustering is then applied to partition the “Dataset of Artists” into disjoint buckets of semantically similar artists.

Step 4 18 involves, for each bucket generated in Step 3 16, selecting all paintings in “Dataset of Artworks” that are done by artists listed in that bucket. This way, each bucket is uniquely associated with only one subset of paintings in the “Dataset of Artworks.” So, the outcome of Step 4 18 is a collection of datasets of artworks.

Step 5 20 involves, for each dataset in a collection of datasets generated in Step 4 18, building the best classifier (of the highest F-score). The winning classifier is used to build a personalized recommender system trained on that dataset. So, the outcome of Step 5 20 is a collection of personalized recommender systems (referred to as the crowd of recommender systems). These are then used for evaluation and pricing of new artworks submitted to the recommender system.

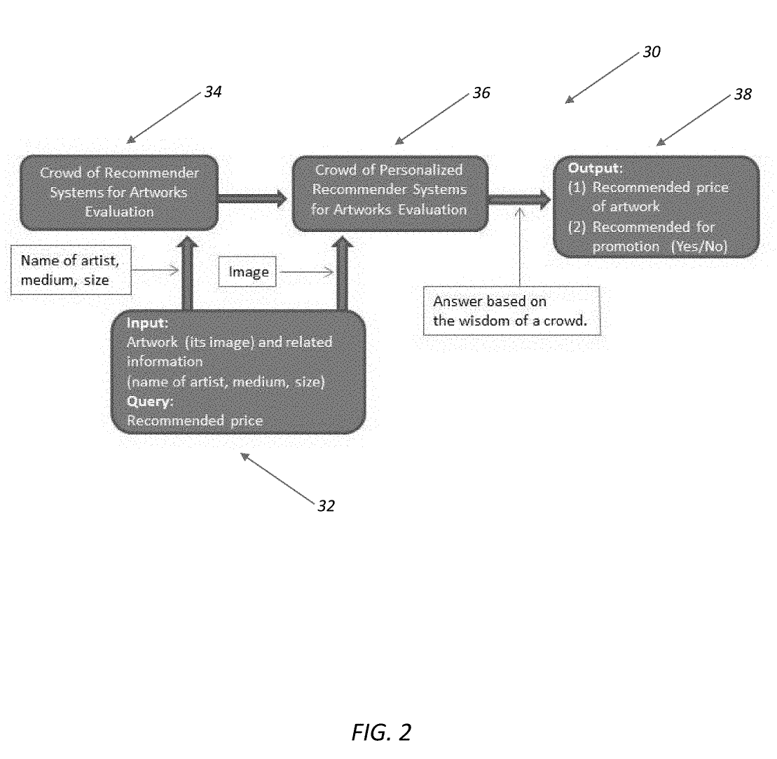

Referring now specifically to FIG. 2, in one exemplary embodiment, the query answering scheme 30 consists of a user submitting an image of an artwork, its size, its medium, and name of the artist to the Query Answering System (QAS) 30 and querying a recommended price. Specifically, the input 32 related to artist name, medium, and size is submitted to the crowd of recommender systems 34 and the image is submitted to the associated crowd of personalized recommender systems 36. If the artist's name is listed in the Dataset of Artists, then the price range of the artworks sold by this artist is identified. Personalized recommender systems for artists targeting similar prices and also personalized recommender systems satisfying certain threshold values are asked to evaluate the submitted artwork. The output 38 of the QAS 30 is the price tag suggested by the crowd. If the artist is not listed in the Dataset of Artists, then personalized recommender systems satisfying certain threshold criteria are asked for an answer and their decision about the suggested price tag (i.e., the decision of the crowd) is provided to the user.

Preferably, the software application(s) of the present disclosure is/are implemented as coded instructions stored in a memory and executed by a processor coupled to the Wed via one or more wired or wireless network links. The processor is a hardware device for executing such coded instructions. The processor can be any custom made or commercially available processor, a central processing unit (CPU), an auxiliary processor among several processors associated with the memory, a semiconductor-based microprocessor (in the form of a microchip or chip set), or generally any device for executing coded instructions. The processor is configured to execute software stored within the memory, to communicate data to and from the memory, and to generally control operations pursuant to the coded instructions. In an exemplary embodiment, the processor may include a mobile optimized processor, such as one optimized for power consumption and mobile applications. I/O interfaces can be used to receive user input and/or for providing system output. User input can be provided via, for example, a keypad, a touch screen, a scroll ball, a scroll bar, buttons, and/or the like. System output can be provided via a display device, such as a liquid crystal display (LCD), touch screen, and/or the like. The I/O interfaces can also include, for example, a serial port, a parallel port, a small computer system interface (SCSI), an infrared (IR) interface, a radio frequency (RF) interface, a universal serial bus (USB) interface, and/or the like. The I/O interfaces can include a GUI that enables a user to interact with the memory. Additionally, the I/O interfaces may further include an imaging device, i.e. camera, video camera, etc.

The memory may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory may incorporate electronic, magnetic, optical, and/or other types of storage media. Note that the memory may have a distributed architecture, where various components are situated remotely from one another, but can be accessed by the processor. The software in memory can include one or more software programs, each of which includes an ordered listing of executable instructions for implementing logical functions. The software in the memory includes a suitable operating system (O/S) and programs. The operating system essentially controls the execution of other computer programs, and provides scheduling, input-output control, file and data management, memory management, and communication control and related services. The programs may include various applications, add-ons, etc. configured to provide end user functionality. The programs can include an application or “app” which provides various functionalities.

Thus, the present disclosure utilizes advanced datamining techniques to provide stakeholders in the art market with reduced risk, better information, and to help facilitate trust from all parties. A crowd of recommender systems is created that helps art market stakeholders secure their investments. Recently, an art collector lost over $100 million due to bad investment decisions. This is not the only such case. Galleries often cannot sustain themselves without outside investment. The systems and methods of the present disclosure help galleries to sustain themselves. Artists will integrate themselves into the art market. Evaluation of art for tax and donation purposes will be accurate.

None of the current art pricing recommender systems are built from the knowledge extracted from large repositories of artworks, where information about art pieces is described by a large variety of features constructed using advanced datamining techniques (including mining biographies of artists and mining customer opinions, using sentiment mining and guided folksonomy, etc.). The resulting crowd of personalized recommender systems built for evaluating each artwork is much more accurate in terms of pricing than a few specialists more or less randomly chosen, which represents the current state-of-the-art.

In summary, the existing tools/services for evaluating and managing fine art (works) are currently based on expert human knowledge. These services are expensive and time consuming. The pricing is done by looking at what a comparable art work was sold for or by making referral to other galleries. In the case of contemporary art, if artists are not well-known and have no sale history, there is a great risk of incorrect evaluation and mistakes. One of the basic methods of pricing artwork is to calculate value of scale (per-square-inch) and medium, which does not give sufficient accuracy. Therefore, today's global art market is vulnerable to money laundering, tax evasion and price manipulation.

The present disclosure provides an interactive software system to help stakeholders in the art market assign price tags to artwork and to manage their art inventories. The system is based on big data analytics. Two separate datasets are built from information extracted from the Web: the Art-Dataset describing fine art pieces in terms of features having impact on their prices and the Artists-Dataset describing artists in terms of features that may have impact on their artwork prices. These two datasets are used to construct a crowd of recommender systems for making recommendations about the pricing and evaluation of fine art works. Appraisal of an art piece is done by a personalized sub-crowd of recommender systems. More than 100 features, describing each art piece, have been constructed and used. A wisdom of the crowd approach and crowd personalization have been used for recommending the price tags. Semantic distance between artists has been introduced and they have been partitioned into clusters. For each cluster, a personalized recommender system is built from classifiers trained on the dataset describing artworks sold by artists belonging to that cluster. These personalized systems form the crowd. To evaluate fine art work, a personalization strategy is used to construct the right sub-crowd of that crowd to do the evaluation. The system can be used to predict the value of an art investment, to support the financial stability of galleries through better decisions about promotion of artists and exhibitions, to improve trust in the art market, and to help artists maintain control of the commercial aspects of their work as well as boost their self-confidence.

Although the present disclosure is illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A method for providing a recommender system for the pricing and evaluation of fine art works and the like, comprising:
building a plurality of initial datasets from information obtained from the Web, wherein the plurality of initial datasets comprise an initial Artist Dataset and an initial Artwork Dataset;
adding features to the plurality of initial datasets to generate a plurality of final datasets that are configured to be datamined, wherein the plurality of final datasets comprise a final Artist Dataset and a final Artwork Dataset;
introducing semantic distance into one or more of the plurality of final datasets;
selectively associating the final Artist Dataset with the final Artwork Dataset; and
for each of the plurality of final datasets, building a classifier and training a plurality of personalized recommender systems using the classifiers, wherein the plurality of personalized recommender systems form a crowd of recommender systems configured to be used for evaluation and pricing of a new art piece submitted to the recommender system by a user.

2. The method of claim 1, wherein building the plurality of initial datasets from information obtained from the Web comprises:
indexing webpages comprising the relevant information;
loading the indexed webpages into a full-text search engine application and parsing the indexed webpages;
extracting data stored in the indexed and parsed webpages;
loading the extracted data into a distributed database management system; and
fetching images associated with the information to a file system.

3. The method of claim 1, wherein adding features to the plurality of initial datasets to generate the plurality of final datasets that are configured to be datamined comprises building the features using one or more of text mining, sentiment mining, and guided folksonomy.

4. The method of claim 1, further comprising applying agglomerative clustering to one or more of the plurality of final datasets to partition the one or more of the plurality of datasets into disjoint buckets of semantically similar categories.

5. The method of claim 1, wherein the recommender system is operable for receiving input and a query from the user.

6. The method of claim 5, wherein the input comprises one or more of: (1) information related to one or more of an artist and the new art piece and (2) an image of the new art piece.

7. The method of claim 6, wherein the input is received by one or more of the plurality of personalized recommender systems and the crowd of recommender systems.

8. The method of claim 1, wherein the recommender system is operable for delivering output to the user comprising one or more of a suggested price for the new art piece and a recommendation for promotion related to the new art piece based on crowd wisdom.

9. A recommender system for the pricing and evaluation of fine art works and the like, comprising:
an algorithm stored in a memory and executed by a processor operable for building a plurality of initial datasets from information obtained from the Web, wherein the plurality of initial datasets comprise an initial Artist Dataset and an initial Artwork Dataset;
an algorithm stored in the memory and executed by the processor operable for adding features to the plurality of initial datasets to generate a plurality of final datasets that are configured to be datamined, wherein the plurality of final datasets comprise a final Artist Dataset and a final Artwork Dataset;
an algorithm stored in the memory and executed by the processor operable for introducing semantic distance into one or more of the plurality of final datasets;
an algorithm stored in the memory and executed by the processor operable for selectively associating the final Artist Dataset with the final Artwork Dataset; and
an algorithm stored in the memory and executed by the processor operable for, for each of the plurality of final datasets, building a classifier and training a plurality of personalized recommender systems using the classifiers, wherein the plurality of personalized recommender systems form a crowd of recommender systems configured to be used for evaluation and pricing of a new art piece submitted to the recommender system by a user.

10. The system of claim 9, wherein building the plurality of initial datasets from information obtained from the Web comprises:
indexing webpages comprising the information;
loading the indexed webpages into a full-text search engine application and parsing the indexed webpages;
extracting data stored in the indexed and parsed webpages;
loading the extracted data into a distributed database management system; and
fetching images associated with the information to a file system.

11. The system of claim 9, wherein adding features to the plurality of initial datasets to generate the plurality of final datasets that are configured to be datamined comprises building the features using one or more of text mining, sentiment mining, and guided folksonomy.

12. The system of claim 9, further comprising an algorithm stored in the memory and executed by the processor operable for applying agglomerative clustering to one or more of the plurality of final datasets to partition the one or more of the plurality of datasets into disjoint buckets of semantically similar categories.

13. The system of claim 9, wherein the recommender system is operable for receiving input and a query from the user.

14. The system of claim 13, wherein the input comprises one or more of: (1) information related to one or more of an artist and the new art piece and (2) an image of the new art piece.

15. The system of claim 14, wherein the input is received by one or more of the plurality of personalized recommender systems and the crowd of recommender systems.

16. The system of claim 9, wherein the recommender system is operable for delivering output to the user comprising one or more of a suggested price for the new art piece and a recommendation for promotion related to the new art piece based on crowd wisdom.

17. A method for using a recommender system for the pricing and evaluation of fine art works and the like, comprising:
accessing the recommender system;
providing user input and a user query to the recommender system, wherein the input comprises one or more of: (1) information related to one or more of an artist and a new art piece and (2) an image of the new art piece, and wherein the input is received by one or more of a plurality of personalized recommender systems and a crowd of recommender systems; and
receiving output from the recommender system comprising one or more of a suggested price for the new art piece and a recommendation for promotion related to the new art piece based on crowd wisdom.

18. The method of claim 17, wherein the recommender system is constructed by:
building a plurality of initial datasets from information obtained from the Web, wherein the plurality of initial datasets comprise an initial Artist Dataset and an initial Artwork Dataset;
adding features to the plurality of initial datasets to generate a plurality of final datasets that are configured to be datamined, wherein the plurality of final datasets comprise a final Artist Dataset and a final Artwork Dataset;
introducing semantic distance into one or more of the plurality of final datasets;
selectively associating the final Artist Dataset with the final Artwork Dataset; and
for each of the plurality of final datasets, building a classifier and training the plurality of personalized recommender systems using the classifiers, wherein the plurality of personalized recommender systems form the crowd of recommender systems configured to be used for the evaluation and pricing of the new art piece submitted to the recommender system by a user.

19. The method of claim 18, wherein building the plurality of initial datasets from information obtained from the Web comprises:
indexing webpages comprising the information;
loading the indexed webpages into a full-text search engine application and parsing the indexed webpages;
extracting data stored in the indexed and parsed webpages;
loading the extracted data into a distributed database management system; and
fetching images associated with the information to a file system.

20. The method of claim 18, wherein adding features to the plurality of initial datasets to generate the plurality of final datasets that are configured to be datamined comprises building the features using one or more of text mining, sentiment mining, and guided folksonomy.

21. The method of claim 18, wherein the recommender system is further constructed by applying agglomerative clustering to one or more of the plurality of final datasets to partition the one or more of the plurality of datasets into disjoint buckets of semantically similar categories.

22. A recommender system for the pricing and evaluation of fine art works and the like, comprising:
an algorithm stored in a memory and executed by a processor operable for allowing a user to access the recommender system;
an algorithm stored in the memory and executed by the processor operable for receiving user input and a user query at the recommender system, wherein the input comprises one or more of: (1) information related to one or more of an artist and a new art piece and (2) an image of the new art piece, and wherein the input is received by one or more of a plurality of personalized recommender systems and a crowd of recommender systems; and
an algorithm stored in the memory and executed by the processor operable for delivering output from the recommender system to the user comprising one or more of a suggested price for the new art piece and a recommendation for promotion related to the new art piece based on crowd wisdom.

23. The system of claim 22, wherein the recommender system is constructed by:
building a plurality of initial datasets from information obtained from the Web, wherein the plurality of initial datasets comprise an initial Artist Dataset and an initial Artwork Dataset;
adding features to the plurality of initial datasets to generate a plurality of final datasets that are configured to be datamined, wherein the plurality of final datasets comprise a final Artist Dataset and a final Artwork Dataset;
introducing semantic distance into one or more of the plurality of final datasets;
selectively associating the final Artist Dataset with the final Artwork Dataset; and
for each of the plurality of final datasets, building a classifier and training the plurality of personalized recommender systems using the classifiers, wherein the plurality of personalized recommender systems form the crowd of recommender systems configured to be used for the evaluation and pricing of the new art piece submitted to the recommender system by a user.

24. The system of claim 23, wherein building the plurality of initial datasets from information obtained from the Web comprises:
indexing webpages comprising the information;
loading the indexed webpages into a full-text search engine application and parsing the indexed webpages;
extracting data stored in the indexed and parsed webpages;
loading the extracted data into a distributed database management system; and
fetching images associated with the information to a file system.

25. The system of claim 23, wherein adding features to the plurality of initial datasets to generate the plurality of final datasets that are configured to be datamined comprises building the features using one or more of text mining, sentiment mining, and guided folksonomy.

26. The system of claim 23, wherein the recommender system is further constructed by applying agglomerative clustering to one or more of the plurality of final datasets to partition the one or more of the plurality of datasets into disjoint buckets of semantically similar categories.
